(19) United States
(12) Patent Application Publication
(10) Pub. No.: US 2019/0263347 A1
(43) Pub. Date: Aug. 29, 2019

(54) AIRBAG APPARATUS FOR VEHICLE

(71) Applicants: HYUNDAI MOTOR COMPANY, Seoul (KR); KIA MOTORS CORPORATION, Seoul (KR)

(72) Inventor: Jae Ho CHOI, Seoul (KR)

(21) Appl. No.: 16/122,210

(22) Filed: Sep. 5, 2018

(30) Foreign Application Priority Data
Feb. 23, 2018 (KR) 10-2018-0021623

(51) Int. Cl. B60R 21/2338; B60R 21/205

(52) U.S. Cl. CPC B60R 21/2338; B60R 2021/0048; B60R 21/205

(57) ABSTRACT

An airbag apparatus for a vehicle includes: an airbag cushion disposed in the vehicle to be in front of an occupant, the airbag cushion inflating rearwards toward the occupant and laterally upon deployment; a plurality of restraint tethers, each of which having: a first end connected to a front side of the airbag cushion; and a second end connected to a rear end portion or a side end portion of the airbag cushion, each of the plurality of restraint tethers restraining inflation of the airbag cushion to determine a shape of the airbag cushion upon full deployment; and a cushion adjusting mechanism configured to selectively cut or not cut the plurality of restraint tethers upon the deployment, such that a first cushion portion of the airbag cushion inflates more than a second cushion portion of the airbag cushion.

### CROSS REFERENCE TO RELATED APPLICATION

The present application claims priority to Korean Patent Application No. 10-2018-0021623, filed Feb. 23, 2018, the entire contents of which is incorporated herein for all purposes by this reference.

### TECHNICAL FIELD

The present disclosure relates to an airbag apparatus for a vehicle, which provides stable protection to an occupant against vehicle collisions in various collision directions.

### BACKGROUND

As well known in the art, techniques for ensuring occupant safety have been developed in addition to techniques for improving a driving performance, convenience, and functionality of a vehicle.

In particular, of various safety devices applied to vehicles, an airbag has been used as the most efficient system of protecting occupants.

Such an airbag is a device for protecting a driver and passengers in the event of a vehicle collision, and is configured with a collision sensor for detecting the vehicle collision, a controller for activating the airbag according to the detection result of the collision sensor, and an airbag module for activating the airbag in response to a signal from the controller. The airbag is categorized into a driver airbag, a passenger airbag, a side airbag, a roof airbag, etc., depending on an installation position and a protection target.

In recent years, safety has been considered not only for a frontal collision and a side collision but also for an oblique collision in which a collision occurs from a diagonal direction of a vehicle. However, an airbag that deploys in front of an occupant safely protects the occupant only in the event of the frontal collision, but may not cope with occupant's motion in the event of the oblique collision.

In other words, in the event of the oblique collision, the occupant's upper body is moved forwards in an oblique manner, that the occupant's upper body may not be positioned within a protection range of the airbag that deploys in front of the occupant. In addition, the airbag that deploys in front of the occupant may cause rotation of the head and the torso during the oblique collision, resulting in a secondary injury.

The foregoing is intended merely to aid in the understanding of the background of the present disclosure, and is not intended to mean that the present disclosure falls within the purview of the related art that is already known to those skilled in the art.

### SUMMARY

The present disclosure has been made keeping in mind the above problems occurring in the related art, and the present disclosure provides an airbag apparatus for a vehicle, which provides stable protection to an occupant by varying an inflation shape of the airbag apparatus depending, on vehicle collisions in various collision directions such as a frontal collision, a side collision, and an oblique collision.

According to one aspect of the present disclosure, an airbag apparatus for a vehicle includes: an airbag cushion disposed in the vehicle in front of an occupant and inflating rearwards toward the occupant and laterally upon deployment; a plurality restraint tethers, each of which having a first end connected to a front side of the airbag cushion and a second end connected to a rear end portion or a side end portion of the airbag cushion, the restraint tether being configured to restrain inflation of the airbag cushion to determine a shape of the airbag cushion upon full deployment; and a cushion adjusting mechanism configured to selectively cut or not cut the restraint tethers upon the deployment, such that a first cushion portion of the airbag cushion which is associated with a direction in which the occupant moves in an event of a vehicle collision is inflated more than a second cushion portion of the airbag cushion.

The airbag cushion may be configured with a left chamber and a right chamber communicating with each other, and the restraint tethers are configured with a left tether portion restraining inflation of the left chamber and a right tether portion restraining inflation of the right chamber.

The left tether portion may be configured with a first left tether fixed at a first end thereof to the front side of the airbag cushion and connected at a second end thereof to a left end portion of the left chamber, and a second left tether fixed at a first end thereof to the front side of the airbag cushion and connected at a second end thereof to a rear end portion of the left chamber, and the right tether portion may be configured with a first right tether fixed at a first end thereof to the front side of the airbag cushion and connected at a second end thereof to a right end portion of the right chamber, and a second right tether fixed at a first end thereof to the front side of the airbag cushion and connected at a second end thereof to a rear end portion of the right chamber.

In the case of a collision mode in which the occupant impacts a surface of the airbag cushion, the surface facing the occupant, the cushion adjusting mechanism may cut the second left and right tethers rather than cutting the first left and right tethers.

In the case of a collision mode in which the occupant impacts a left side of the airbag cushion, the cushion adjusting mechanism may cut the first and second left tethers rather than cutting the first and second right tethers.

In the case of a collision mode in which the occupant impacts a left side of the airbag cushion, the cushion adjusting mechanism may cut the first and second left tethers and the second right tether rather than cutting the first right tether.

In the case of a collision mode in which the occupant impacts a right side of the airbag cushion, the cushion adjusting mechanism may cut the first and second right tethers rather than cutting the first and second left tethers, such that the airbag cushion is inflated rightwards.

In the case of a collision mode in which the occupant impacts a right side of the airbag cushion, the cushion adjusting mechanism may cut the first and second right tethers and the second left tether rather than cutting the first left tether.

When the vehicle collision occurs while the occupant is seated in a passenger's seat, the cushion adjusting mechanism may cut the first left tether when the occupant is seated in a left passenger's seat, and may cut the first right tether when the occupant is seated in a right passenger's seat.

The left tether portion may further include a third left tether fixed at a first end thereof to the front side of the airbag cushion and connected at a second end thereof to the rear end portion of the left chamber, the third left tether being formed longer than the second left tether, and the right tether portion may further include a third right tether fixed at a first end thereof to the front side of the airbag cushion and connected at a second end thereof to the rear end portion of the right chamber, the third right tether being formed longer than the second right tether.

In the case of a collision mode in which the occupant impacts a left side of the airbag cushion, the cushion adjusting mechanism may cut the first right tether and the first and second left tethers rather than cutting the second right tether and the third left tether.

In the case of a collision mode in which the occupant impacts a right side of the airbag cushion, the cushion adjusting mechanism may cut the first left tether and the first and second right tethers rather than cutting the second left tether and the third right tether.

The cushion adjusting mechanism may include: a cutter provided on the front side of the airbag cushion and configured to selectively cut the left tether portion or the right tether portion during operation; and a controller receiving vehicle collision information, and controlling the cutter such that the first cushion portion of the airbag cushion which is associated with the direction in which the occupant is moved in the event of the vehicle collision is inflated more than the second cushion portion of the airbag cushion.

The left tether portion and the right tether portion may he formed in a panel shape extending in a vertical direction of the airbag cushion.

The airbag cushion may be configured such that the right and left chambers are folded leftwards and rightwards, respectively, and then rear end portions of the left and right chambers are folded forwards, whereby the airbag cushion is inflated and deployed toward the occupant and then is deployed leftwards and rightwards.

The airbag apparatus for a vehicle having the above-described configuration varies the inflation shape thereof depending on vehicle collisions in various collision directions such as a frontal collision, a side collision, an oblique collision, etc. Thus, it is possible to stably protect an occupant, to reduce impact to the occupant, and to prevent twisting of the head or the torso of the occupant cushioned by the airbag apparatus and thus to provide optimal occupant protection performance for the occupant.

### BRIEF DESCRIPTION OF THE DRAWINGS

The above and other objects, features, and other advantages of the present disclosure will be more clearly understood from the following detailed description when taken in conjunction with the accompanying drawings, in which:

FIG. 1 is a view showing an airbag apparatus for a vehicle according to an embodiment of the present disclosure; and

FIGS. 2 to 10 are views showing the airbag apparatus or the vehicle shown in FIG. 1.

### DETAILED DESCRIPTION

Hereinbelow, an airbag apparatus for a vehicle according to exemplary embodiments of the present disclosure will be described in detail with reference to the accompanying drawings. Throughout the drawings, the same reference numerals will refer to the same or like parts.

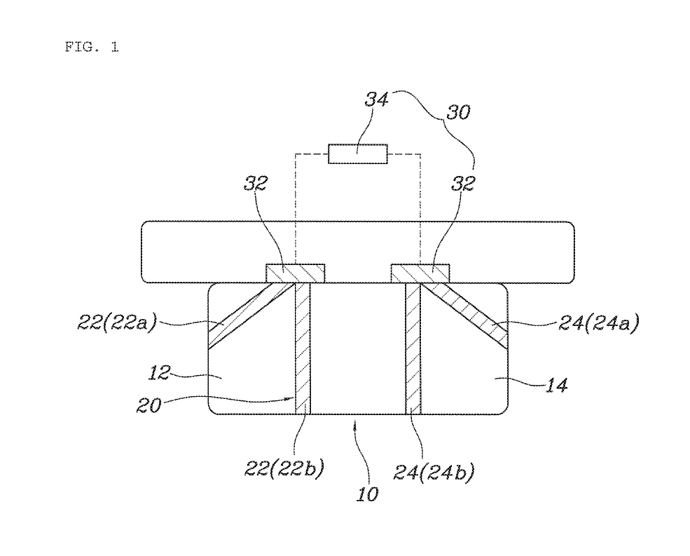

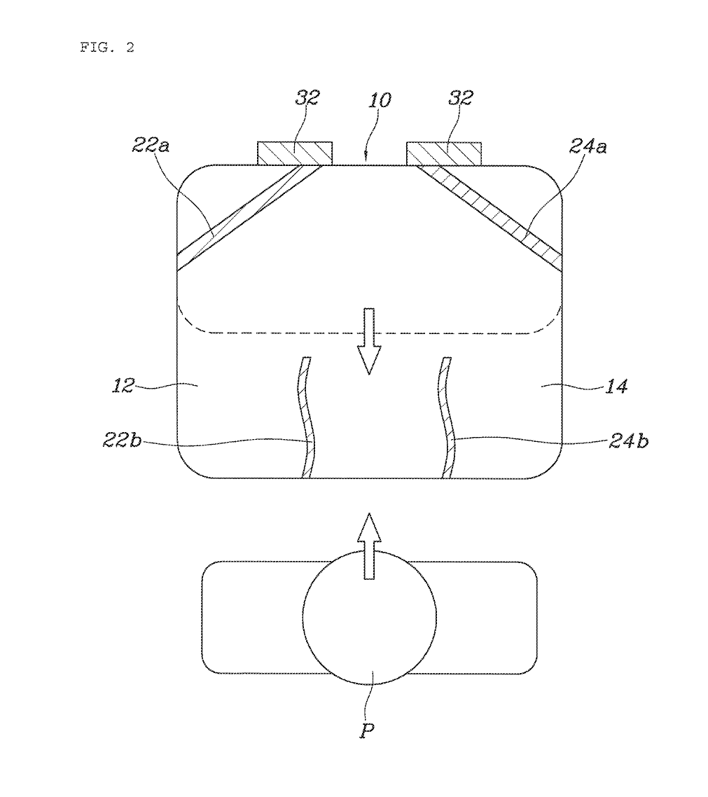

FIG. 1 is a view showing an airbag apparatus for a vehicle according to an embodiment of the present disclosure, and FIGS. 2 to 10 are views showing the airbag apparatus for the vehicle shown in FIG. 1.

As shown in FIG. 1, an airbag apparatus for a vehicle according to the present disclosure includes: an airbag cushion 10 provided in the vehicle in front of an occupant P and inflated rearwards toward the occupant P and laterally upon deployment; a plurality restraint tethers 20 each fixed at a first end thereof to a front side of the airbag cushion 10 and connected at a second end thereof to a rear end portion or a side end portion of the airbag cushion 10, the restraint tether being configured to restrain inflation of the airbag cushion 10 so as to determine a shape of the airbag cushion 10 upon full deployment; and a cushion adjusting mechanism 30 configured to selectively cut or not cut the restraint tethers 20 upon the deployment, such that a first cushion portion of the airbag cushion 10 which is associated with a direction in which the occupant P is moved in the event of a vehicle collision is inflated more than a second cushion portion of the airbag cushion 10. Herein, the front side of the airbag cushion 10 to which the first end of the restraint tether 20 is connected may be a front end portion of the airbag cushion 10, or a vehicle body, or an airbag housing.

As such, according to the present disclosure, the shape of the airbag cushion 10 upon full deployment is determined by the plurality of restraint tethers 20 provided therein, and the plurality of restraint tethers 20 is selectively cut or not cut by the cushion adjusting mechanism 30, whereby the shape of the airbag cushion 10 varies upon full deployment. In particular, the cushion adjusting mechanism 30 allows the plurality of restraint tethers 20 to be cut or not cut such that the first cushion portion of the airbag cushion 10 is inflated toward the direction in which the occupant P is moved in the event of a vehicle collision.

In other words, a moving direction of the occupant P varies depending on a direction of a vehicle collision, and one of the restraint tethers 20 which is associated with the first cushion portion corresponding to the moving direction of the occupant P is cut by the cushion adjusting mechanism 30. Accordingly, the first cushion portion associated with the cut restraint tether 20 is inflated more than the second cushion portion associated with an uncut remaining one of the restraint tethers 20.

Consequently, the shape of the airbag cushion 10 upon full deployment is determined in response to the occupant P moving in the direction of the vehicle collision, whereby the occupant P can be safely protected by the airbag cushion 10 in the event of a vehicle collision.

In detail, as shown in FIG. 1, the airbag cushion 10 may be configured with a left chamber 12 and a right chamber 14 communicating with each other, and the restraint tethers 20 may be configured with a left tether portion 22 restraining inflation of the left chamber 12 and a right tether portion 24 restraining inflation of the right chamber 14.

Herein, the airbag cushion 10 is divided into the left chamber 12 and the right chamber 14, but the left and right chambers 12 and 14 communicate with each other, so that the airbag cushion 10 may he formed as a single body. The left and right chambers 12 and 14 may be formed such that upon full deployment, the left and right chambers 12 and 14 are inflated leftwards and rightwards, respectively, to a size larger than a size of the occupant P.

Furthermore, the left tether portion, 22 and the right tether portion 24 are formed in a panel shape extending in a vertical direction of the airbag cushion 10, such that restraint forces exerting on the left and right chambers 12 and are secured, and, vertical shapes of the left and right chambers 12 and 14 upon full deployment are constant.

The left and right tether portions 22 and 24 are respectively provided in the left and right chambers 12 and 14, whereby shapes of the left and right chambers 12 and 14 upon full deployment are determined. In other words, in a case where the left tether portion 22 is cut, the restraint force exerting on the left chamber 12 is released and thus the left chamber 12 may be inflated to a size larger than when the left tether portion 22 remains uncut. In a case where the right tether portion 24 is cut, the right chamber 14 may be inflated to a size larger than when the right tether portion 24 remains uncut.

In detail, as shown in FIG. 1, the left tether portion 22 may be configured with a first left tether 22a fixed at a first end thereof to the front side of the airbag cushion 10 and connected at a second end thereof to a left end portion of the left chamber 12, and a second left tether 22b fixed at a first end thereof to the front side of the airbag cushion 10 and connected at a second end thereof to a rear end portion of the left chamber 12. The right tether portion 24 may be configured with a first right tether 24a fixed at a first end thereof to the front side of the airbag cushion 10 and connected at a second end thereof to a right end portion of the right chamber 14, and a second right tether 24b fixed at a first end thereof to the front side of the airbag cushion 10 and connected at a second end thereof to a rear end portion of the right chamber 14.

In other words, the first left tether 22a of the left tether portion 22 restrains leftward inflation of the left chamber 12 while the second left tether 22b of the left tether portion 22 restrains rearward inflation of the left chamber 12, whereby the shape of the left chamber 12 upon full deployment is determined by the first and second left tethers 22a and 22b.

Furthermore, the first right tether 24a of the right tether portion 24 restrains rightward inflation of the right chamber 14 while the second right tether 24b of the right tether portion 24 restrains rearward inflation of the right chamber 14, whereby the shape of the right chamber 14 upon full deployment is determined by the first and second right tethers 24a and 24b.

As a result, the degree of inflation of the left chamber with respect to forward and leftward directions is determined by the first and second left tethers 22a and 22b, and the degree of inflation of the right chamber 14 with respect to forward and leftward directions is determined by the first and second right tethers 24a and 24b.

Hereinafter, it is to be described in detail that the inflation shape of the airbag cushion 10 is determined as the restraint tethers 20 are selectively cut or not cut by the cushion adjusting mechanism 30.

The cushion adjusting mechanism 30 may include: a cutter 32 installed on the front side of the airbag cushion 10 and configured to selectively cut the left tether portion 22 or the right tether portion 24 during operation; and a controller 34 receiving vehicle collision information, and controlling the cutter 32 such that the first cushion portion of the airbag cushion 10 which is associated with the direction in which the occupant P is moved in the event of a vehicle collision is inflated more than the second cushion portion of the airbag cushion 10.

Herein, the cutter 32 is operated under the control of the controller 34, and a method of transferring the restraint tethers 20 by using a cutting blade and an electromagnet may be employed. A technique of cutting the tethers in response to signal input is variously known in the art, and thus a detailed description thereof will be omitted. Furthermore, one cutter 32 may selectively cut or not cut a plurality of left tether portions 22 and a plurality of right tether portions 24. Alternately, a plurality of cutters 32 may be provided such that the cutters 32 are provided respectively at the left and right tether portions 22 and 24 to selectively cut or not cut the left and right tether portions 22 and 24.

In addition, the controller 34 receives the vehicle collision information and controls the cutter 32. Herein, the vehicle collision information is received from a collision detection sensor using a laser or an ultrasonic wave, and the direction in which the occupant P is moved according to the direction of a vehicle collision is predetermined. Accordingly, in the event of a vehicle collision, the controller 34 controls the cutter 32 to selectively cut or not cut the restraint tethers 20, thus allowing the airbag cushion 10 to be inflated in response to the moving direction of the occupant P.

The details will be described according to various embodiments. As shown in FIG. 2, in the case of a collision mode in which the occupant P impacts a surface of the airbag cushion 10, the surface facing the occupant P, the cushion adjusting mechanism 30 may cut the second left and right tethers 22b and 24b rather than cutting the first left and right tethers 22a and 24a.

This is a situation where the front of a vehicle is impacted, and the controller 34 determines that the situation is the collision mode in which the occupant P impacts the occupant-facing surface of the airbag cushion 10, and thus allows the second left and right tethers 22b and 24b to be cut while allowing the first left and right tethers 22a and 24a to remain uncut.

Consequently, as shown in FIG. 2, the left chamber 12 and the right chamber 14 of the airbag cushion 10 are allowed to inflate at the rear end portions thereof rearwards only while being restrained from inflating leftwards and rightwards, respectively. Thus, it is possible to safely protect the occupant P in response to the movement of the occupant P to the front of a vehicle.

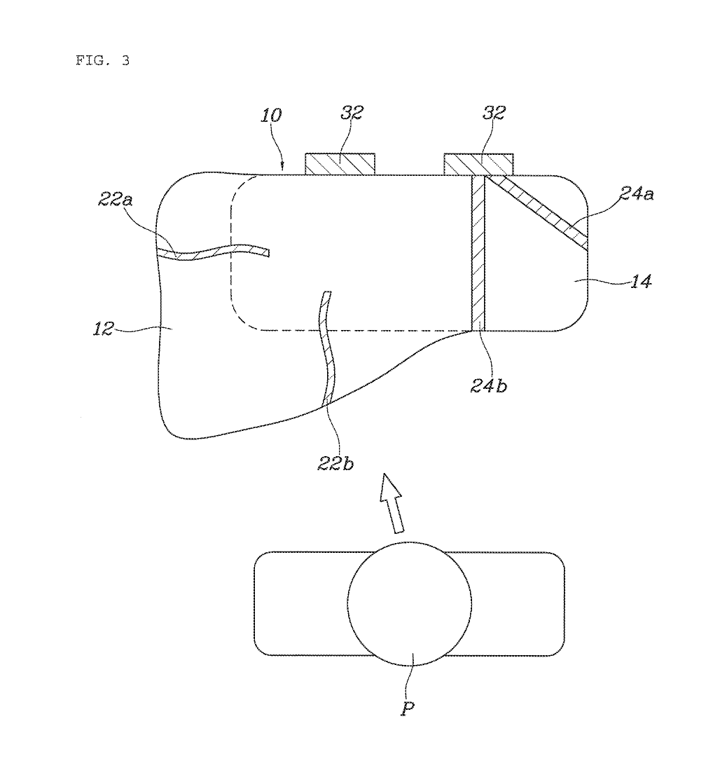

On the other hand, as shown in FIG. 3, in the case of a collision mode in which the occupant P impacts the left side of the airbag cushion 10, the cushion adjusting mechanism 30 may cut the first and second left tethers 22a and 22b rather than cutting the first and second right tethers 24a and 24b.

This is a situation where the left front of a vehicle is impacted, and the controller 34 determines that the situation is the collision mode in which the occupant P impacts the left side of the airbag cushion 10, and thus allows the first and second left tethers 22a and 22b to be cut while allowing the first and second right tethers 24a and 24b to remain uncut. Consequently, as shown in FIG. 3, the left chamber 12 of the airbag cushion 10 is allowed to inflate leftwards and rearwards, while the right chamber 14 is restrained from inflating rightwards. Thus, it is possible to safely protect the occupant P in response to the movement of the occupant P to the left front of a vehicle. In addition, it is possible to prevent the neck of the occupant P from twisting due to the movement of the occupant P to the left front of a vehicle.

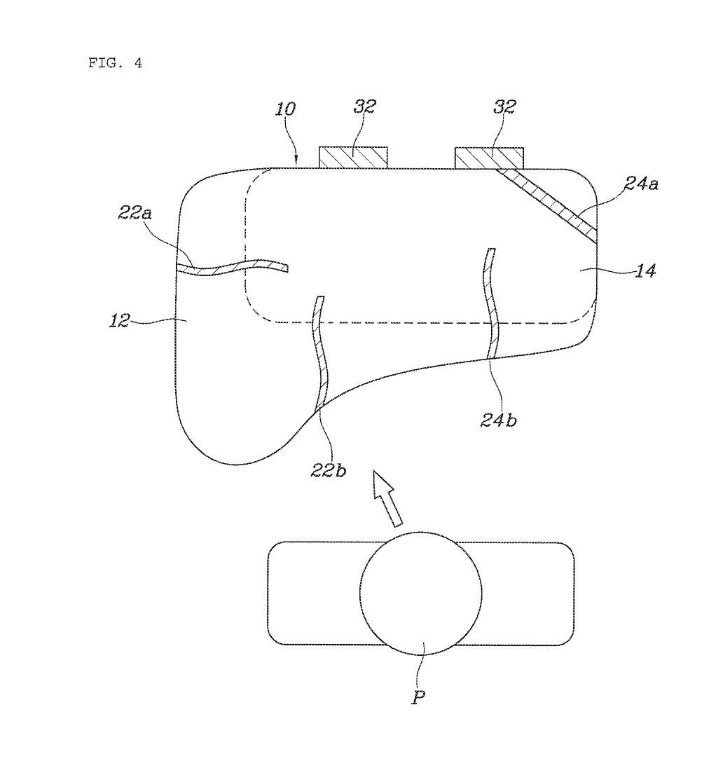

On the other hand, as shown in FIG. 4, in the case of a collision mode in which the occupant P impacts the left side of W the airbag cushion 10, the cushion adjusting mechanism 30 may cut the first and second left tethers 22a and 22b and the second right tether 24b rather than cutting the first right tether 24a.

This is a situation where the left front of a vehicle is impacted, and the controller 34 determines that the situation is the collision mode in which the occupant P impacts the left side of the airbag cushion 10, and thus allows the first and second left tethers 22a and 22b and the second right tether 24b to be cut while allowing the first right tether 24a to remain uncut.

Consequently, as shown in FIG. 4, the left chamber 12 of the airbag cushion 10 is allowed to fully inflate and at the same time the right chamber 14 is allowed to inflate rearwards. Thus, it is possible to safely protect the occupant P in response to the movement of the occupant P to the left front of a vehicle.

Herein, the embodiment shown in FIG. 4 shows the same situation where the occupant P is moved to the left front of a vehicle as in the embodiment shown in FIG. 3. However, in the embodiment shown in FIG. 4, both the left and right chambers 12 and 14 are deployed rearwards, which is more effective at performing stable protection with respect to the front of a vehicle. Accordingly, the embodiment shown in FIG. 3 and the embodiment shown in FIG. 4 may be determined according to the degree to which the occupant P is moved to the left of a vehicle in the event of a vehicle collision, such as, when the occupant P is moved to the left of the vehicle to be relatively far from a longitudinal direction of the vehicle, the embodiment shown in FIG. 3 may be performed, and when the occupant P is moved from the left front to the front of the vehicle to be relatively close to the longitudinal direction of the vehicle, the embodiment shown in FIG. 4 may be performed.

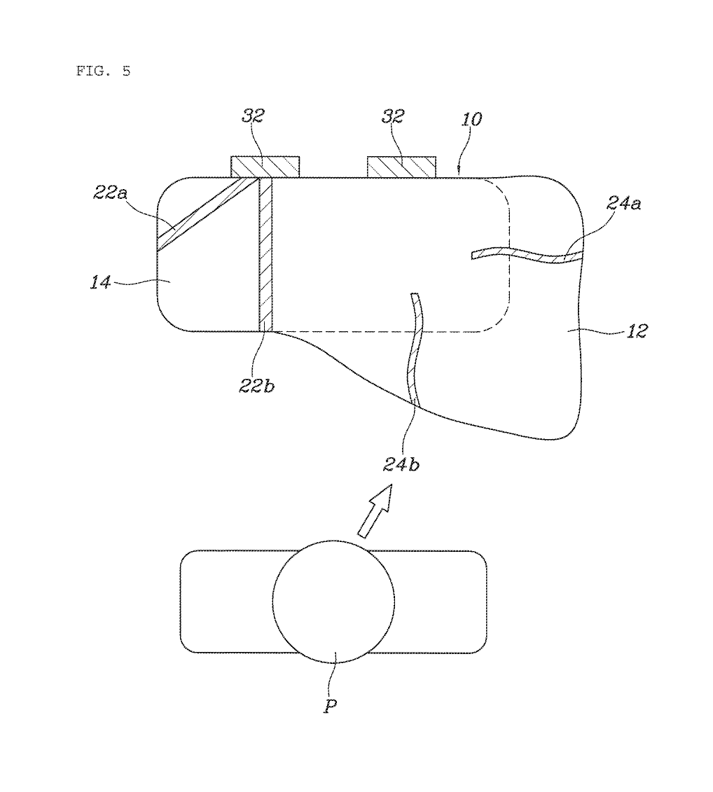

On the other hand, as shown in FIG. 5, in the case of a collision mode in which the occupant P impacts the right side of the airbag cushion 10, the cushion adjusting mechanism 30 may cut the first and second right tethers 24a and 24b rather than cutting the first and second left tethers 22a and 22b, such that the airbag cushion 10 is inflated rightwards.

This is a situation where the right front of a vehicle is impacted, and the controller 34 determines that the situation is the collision mode in which the occupant P impacts the right side of the airbag cushion 10, and thus allows the first and second right tethers 24a and 24b to be cut while allowing the first and second left tethers 22a and 22b to remain uncut. Consequently, as shown in FIG. 5, the right chamber 14 of the airbag cushion 10 is allowed to inflate rightwards and rearwards, while the left chamber 12 is restrained from inflating leftwards. Thus, it is possible to safely protect the occupant P in response to the movement of the occupant P to the right front of a vehicle. In addition, it is possible to prevent the neck of the occupant P from twisting due to the movement of the occupant P to the right front of the vehicle.

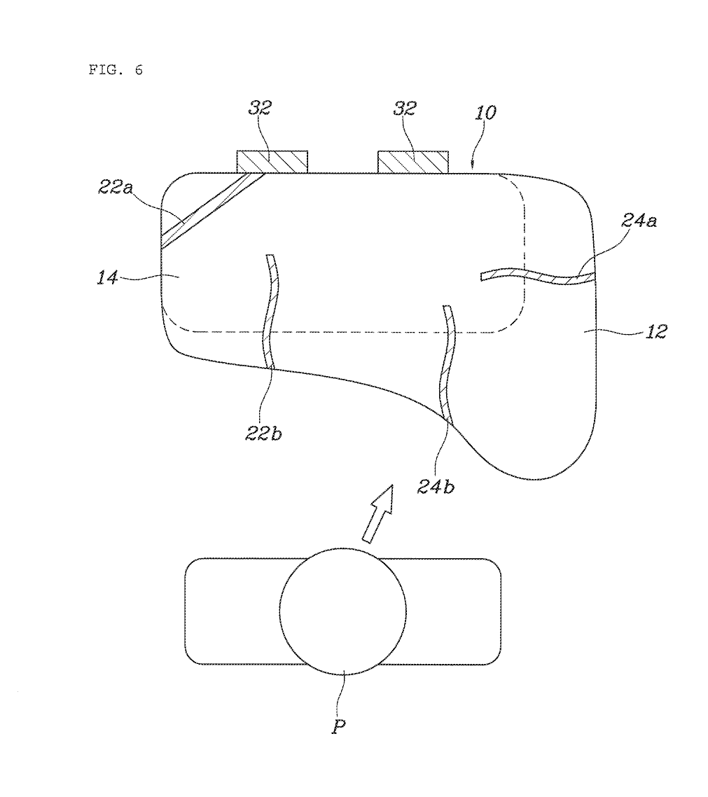

On the other hand, as shown in FIG. 6, in the case of a collision mode in which the occupant P impacts the right side of the airbag cushion 10, the cushion adjusting mechanism 30 may cut the first and second right tethers 24a and 24b and the second left tether 22b rather than cutting the first left tether 22a.

This is a situation where the right front of a vehicle is impacted, and the controller 34 determines that the situation is the collision mode in which the occupant P impacts the right side of the airbag cushion 10, and thus allows the first and second right tethers 24a and 24b and the second left tether 22b to be cut while allowing the first left tether 22a to remain uncut.

Consequently, as shown in FIG. 6, the right chamber 14 of the airbag cushion 10 is allowed to fully inflate and at the same time the left chamber 12 is allowed to inflate rearwards. Thus, it is possible to safely protect the occupant P in response to the movement of the occupant P to the right front of a vehicle.

The embodiment shown in FIG. 5 and the embodiment shown in FIG. 6 may be determined according to the degree to which the occupant P is moved to the right of a vehicle in the event of a M vehicle collision, such as, when the occupant P is moved to the right of the vehicle to be relatively far from the longitudinal direction of the vehicle, the embodiment shown in FIG. 5 may be performed, and when the occupant P is moved from the right front to the front of the vehicle to be relatively close to the longitudinal direction of the vehicle, the embodiment shown in FIG. 6 may be performed.

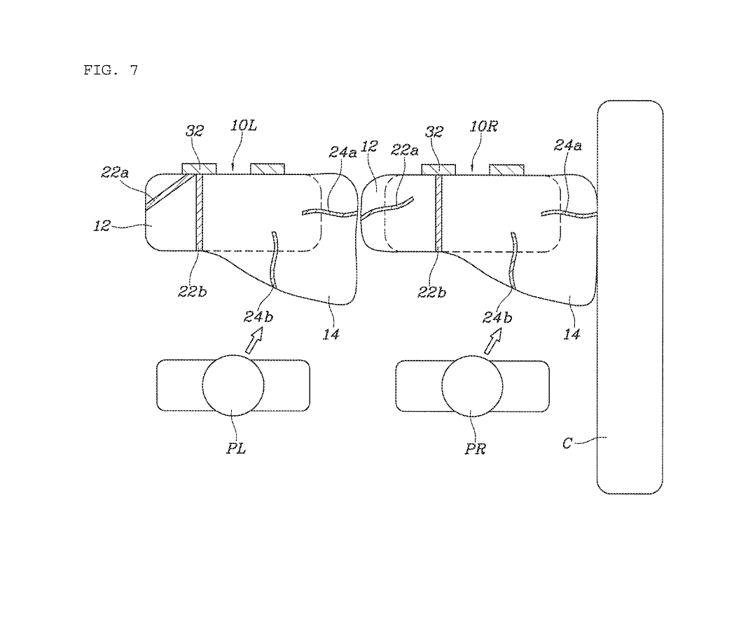

On the other hand, as shown in FIG. 7, when a vehicle collision occurs while the occupant P is seated in a passenger's seat, the cushion adjusting mechanism 30 may cut the first left tether 22a when the occupant P is seated in a left passenger's seat, and may cut the first right tether 24a when the occupant P is seated in a right passenger's seat.

The airbag cushion 10 according to the present disclosure may be provided in front of all occupant seats of a vehicle. For example, when the right front of a vehicle is impacted while the occupant P is seated in both a driver's seat and a passenger's seat, as shown in FIG. 7, both a driver's seat occupant PL and a passenger's seat occupant PR are moved to the right front of the vehicle. Accordingly, an airbag cushion 10L provided in the driver's seat and an airbag cushion 10R provided in the passenger's seat are configured such that the right chamber 14 of each of the airbag cushions 10L and 10R is inflated further, whereby the occupant P is protected against the right front collision.

Herein, the cushion adjusting mechanism 30 may cut the first left tether 22a of the airbag cushion 10R provided in the passenger's seat such that the left chamber 12 is inflated further leftwards. Thus, the driver's seat occupant PL can be more stably cushioned and protected by the airbag cushion 10R provided in the passenger's seat. In addition, the left chamber 12 of the airbag cushion 10R provided in the passenger's seat supports the right chamber 14 of the airbag cushion 10L provided in the driver's seat, and thus cushioning force of the airbag cushion 10 is secured. Furthermore, a gap defined between the airbag cushion 10L provided in the driver's seat and the airbag cushion 10R provided in the passenger's seat is minimized, and thus the driver's seat occupant PL is prevented from entering between the left and right airbag cushions 10L and 10R. Herein, in the case of the passenger's seat occupant PR, a cushioning force may be secured by a curtain airbag C.

As such, when an occupant is seated in the passenger's seat in a vehicle, the shape of the airbag cushion 10 upon inflation varies depending on the direction of a vehicle collision so as to cover a more wide protection range, whereby safety of the occupant in the event of the collision can be further improved.

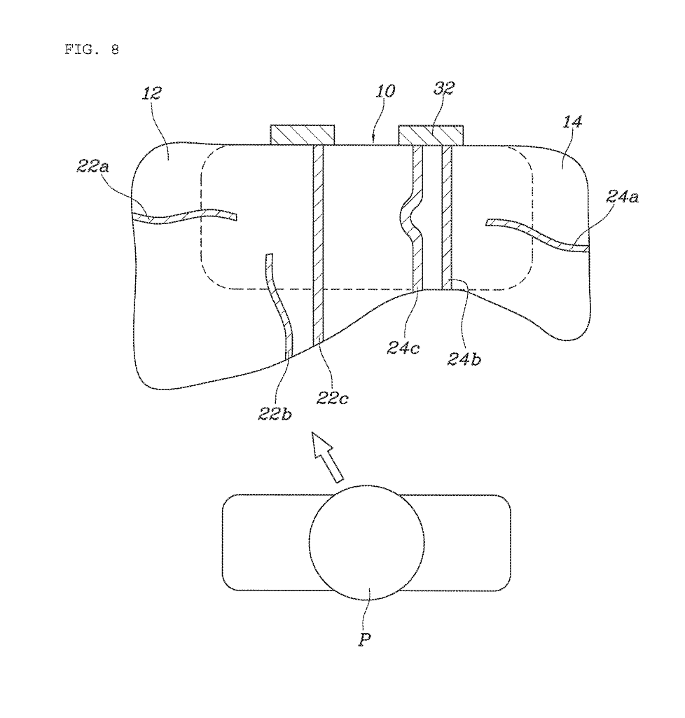

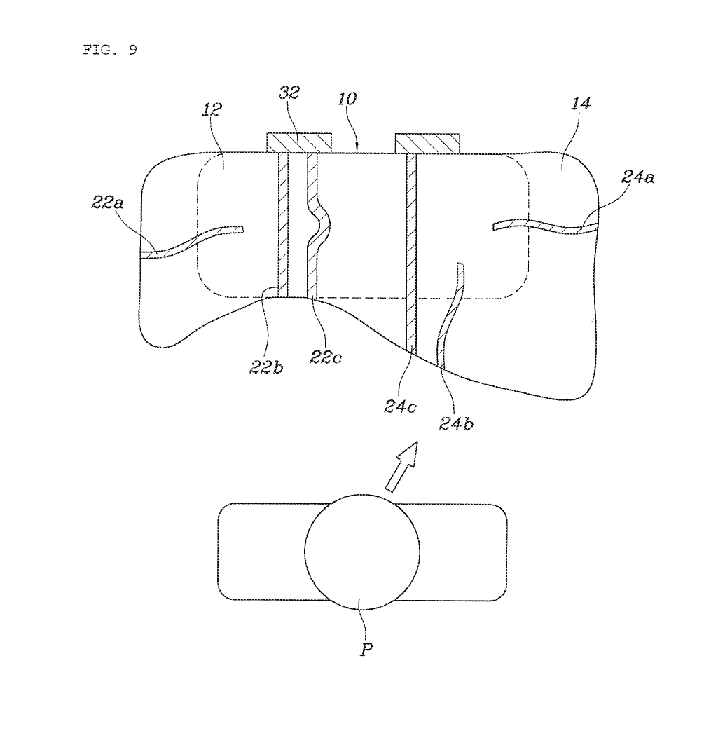

On the other hand, as shown in FIGS. 8 to 9, the left tether portion 22 may further include a third left tether 22c fixed at a first end thereof to the front side of the airbag cushion 10 and connected at a second end thereof to the rear end portion of the left chamber 12, the third left tether being formed longer than the second left tether 22b. The right tether portion 24 may further include a third right tether 24c fixed at a first end thereof to the front side of the airbag cushion 10 and connected at a second end thereof to the rear end portion of the right chamber 14, the third right tether being formed longer than the second right tether 24b.

The third left and right tethers 22c and 24c serve to guide the shape of the airbag cushion 10 that inflates rearwards as the second left and right tethers 22b and 24b are cut. In other words, the third left tether 22c is formed longer than the second left tether 22b, whereby the inflation distance of the left chamber 12, which inflates rearwards as the second left tether 22b is cut, is limited to a distance that corresponds to the length of the third left tether 22c and thus the shape of the left chamber 12 upon full deployment is determined. Similarly, the third right tether 24c is configured such that the shape of the right chamber 14 upon full deployment is determined as the second right tether 24b is cut.

In detail, as shown in FIG. 8, in the case of a collision mode in which the occupant P impacts the left side of the airbag cushion 10, the cushion adjusting mechanism 30 may cut the first right tether 24a and the first and second left tethers 22a and 22b rather than cutting the second right tether 24b and the third left tether 22c.

In other words, in a case where the occupant P impacts the left side of the airbag cushion 10 as the left front of a vehicle 15 is impacted, the first right tether 24a and the first and second left tethers 22a and 22b are cut, while the second right tether 24b and the third left tether 22c remain uncut. Accordingly, the left chamber 12 inflates entirely but the inflation distance thereof is limited to a distance that corresponds to the length of the third left tether 22c, and the right chamber 14 inflates rightwards only.

Consequently, the airbag cushion 10 is inflated as shown in FIG. 8. When the occupant P is brought into contact with the left chamber 12 as the occupant P is moved to the left front of a vehicle, the occupant P is guided to the right chamber 14 and thus the upper body of the occupant P can be prevented from twisting.

On the other hand, as shown in FIG. 9, in the case of a collision mode in which the occupant P impacts the right side of the airbag cushion 10, the cushion adjusting mechanism 30 may cut the first left tether 22a and the first and second right tethers 24a and 24b rather than cutting the second left tether 22b and the third right tether 24c.

In other words, in a case where the occupant P impacts the right side of the airbag cushion 10 as the right front of a vehicle is impacted, the first left tether 22a and the first and second right tethers 24a and 24b are cut, while the second left tether 22b and the third right tether 24c remain uncut. Accordingly, the right chamber 14 inflates entirely but the inflation distance thereof is limited to a distance that corresponds to the length of the third right tether 24c, and the left chamber 12 inflates leftwards only.

Consequently, the airbag cushion 10 is inflated as shown in FIG. 9. When the occupant P is brought into contact with the right chamber 14 as the occupant P is moved to the right front of a vehicle, the occupant P is guided to the left chamber 12 and thus the upper body of the occupant P can be prevented from twisting.

On the other hand, the airbag cushion 10 may be configured such that the right and left chambers 14 and 12 are folded leftwards and rightwards, respectively, and then the rear end portions of the right and left chambers 14 and 12 are folded forwards, whereby the airbag cushion 10 is inflated and deployed toward the occupant P and then is deployed leftwards and rightwards.

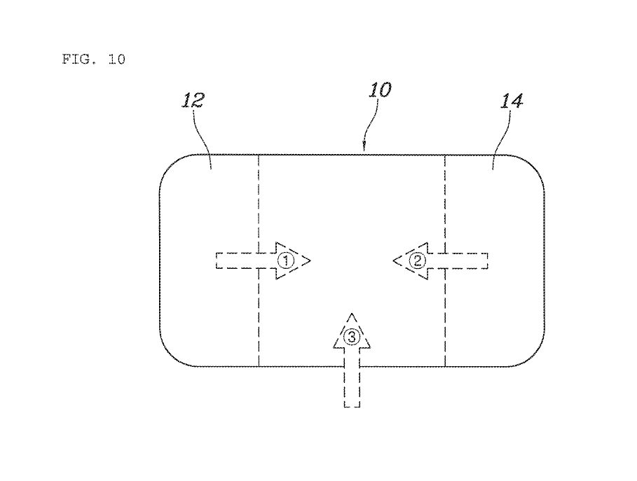

As shown in FIG. 10, the airbag cushion 10 may be configured that the left chamber 12 is partially folded rightwards and the right chamber 14 is partially folded leftwards, and then the rear end portions of the left and right W chambers 12 and 14 are folded forwards. Accordingly, the airbag cushion 10 is inflated such that the rear end portions of the left and right chambers 12 and 14 firstly inflate rearwards toward the occupant P in a reverse order in which the left and right chambers 12 and 14 have been folded, thus providing quick protection, to the occupant P against a vehicle collision. Thereafter, the left chamber 12 or the right chamber 14 can be inflated in response to the moving direction of the occupant P in the event of a vehicle collision.

The airbag apparatus for a vehicle having the above-described configuration varies the inflation shape thereof depending on vehicle collisions in various collision directions such as a frontal collision, side collision, an oblique collision, etc. Thus, it is possible to stably protect the occupant P, to reduce impact to the occupant P, and to prevent twisting of the head or the torso of the occupant P cushioned by the airbag apparatus and thus to provide optimal occupant protection performance for the occupant P.

Although the exemplary embodiment of present disclosure has been described for illustrative purposes, those skilled in the art will appreciate that various modifications, additions and substitutions are possible, without departing from the scope and spirit of the invention as disclosed in the accompanying claims.

What is claimed is:

1. An airbag apparatus for a vehicle, the airbag apparatus comprising:
an airbag cushion disposed in the vehicle to be in front of an occupant, the airbag cushion inflating rearwards toward the occupant and laterally upon deployment;
a plurality of restraint tethers, each of which having; a first end connected to a front side of the airbag cushion; and
a second end connected to a rear end portion or a side end portion of the airbag cushion, each of the plurality of restraint tethers restraining inflation of the airbag cushion. to determine a shape of the airbag cushion upon full deployment; and
a cushion adjusting mechanism configured to selectively cut or not cut the plurality of restraint tethers upon the deployment, such that a first cushion portion of the airbag cushion, which is associated with a direction in which the occupant is moved in an event of a vehicle collision, inflates more than a second cushion portion of the airbag cushion.

2. The airbag apparatus of claim 1, wherein the airbag cushion has a left chamber and a right chamber communicating with each other, and
each of the plurality of restraint tethers includes a left tether portion restraining inflation of the left chamber and a right tether portion restraining inflation of the right chamber.

3. The airbag apparatus of claim 2, wherein the left tether portion includes:
a first left tether having a first end connected to the front side of the airbag cushion, and a second end connected to a left end portion of the left chamber; and
a second left tether having a first end connected to the front side of the airbag cushion, and a second end connected to a rear end portion of the left chamber, and
wherein the right tether portion includes:
a first right tether having a first end connected to the front side of the airbag cushion, and a second end connected to a right end portion of the right chamber; and
a second right tether having a first end connected to the front side of the airbag cushion, and a second end connected to a rear end portion of the right chamber.

4. The airbag apparatus of claim 3, wherein in a case of a collision mode in which the occupant impacts a surface of the airbag cushion, the surface facing the occupant, the cushion adjusting mechanism cuts the second left and right tethers.

5. The airbag apparatus of claim 3, wherein in a case of a collision mode in which the occupant impacts a left side of the airbag cushion, the cushion adjusting mechanism cuts the first and second left tethers.

6. The airbag apparatus of claim 3, wherein in a case of a collision mode in which the occupant impacts a left side of the airbag cushion, the cushion adjusting mechanism cuts the first and second left tethers and the second right tether.

7. The airbag apparatus of claim 3, wherein in a case of a frontal collision mode in which the occupant is seated by moving a seat to the left or a collision mode in which the occupant impacts a left side of the airbag cushion, the cushion adjusting mechanism cuts the first and second left tethers.

8. The airbag apparatus of claim 3, wherein in a case of a collision mode in which the occupant impacts a right side of the airbag cushion, the cushion adjusting mechanism cuts the first and second right tethers, such that the airbag cushion inflates rightwards.

9. The airbag apparatus of claim 3, wherein in a case of a collision mode in which the occupant impacts a right side of the airbag cushion, the cushion adjusting mechanism cuts the first and second right tethers and the second left tether.

10. The airbag apparatus of claim 3, wherein in a case of a frontal collision mode in which the occupant is seated by moving a seat to the right or a collision mode in which the occupant impacts a right side of the airbag cushion, the cushion adjusting mechanism cuts the first and second right tethers and the second left tether.

11. The airbag apparatus of claim 3, wherein when collision. occurs while the occupant is seated in a passenger's seat, the cushion adjusting mechanism cuts the first left tether when the occupant is seated in a left passenger's seat, and cuts the first right tether when the occupant is seated in a right passenger's seat.

12. The airbag apparatus of claim 3, wherein the left tether portion further includes a third left tether having a first end connected to the front side of the airbag cushion, and a second end connected to the rear end portion of the left chamber, the third left tether having a length longer than that of the second left tether, and
the right tether portion further includes a third right tether having a first end connected to the front side of the airbag cushion, and a second end connected to the rear end portion of the right chamber, the third right tether having a length longer than that of the second right tether.

13. The airbag apparatus of claim 12, wherein in a case of a collision mode in which the occupant impacts a left side of the airbag cushion, the cushion adjusting mechanism cuts the first right tether and the first and second left tethers.

14. The airbag apparatus of claim 12, wherein in a case of a collision mode in which the occupant impacts a right side of the airbag cushion, the cushion adjusting mechanism cuts the first left tether and the first and second right tethers. 15, The airbag apparatus of claim 2, wherein the cushion adjusting mechanism includes:
a cutter disposed at the front side of the airbag cushion and selectively cut the left tether portion or the right tether portion; and
a controller configured to receive vehicle collision information, and control the cutter such that the first cushion portion of the airbag cushion, which is associated with the direction in which the occupant is moved in the event of the vehicle collision, inflates more than the second cushion portion of the airbag cushion.

16. The airbag apparatus of claim 2, wherein the left tether portion and the right tether portion have a panel shape extending, in a vertical direction of the airbag cushion.

17. The airbag apparatus of claim 2, wherein the right and left chambers are folded leftwards and rightwards, respectively, and then rear end portions of the left and right chambers are folded forwards,
wherein the airbag cushion inflates and deploys toward the occupant and then deploys leftwards and rightwards.
